(19) United States
(12) Patent Application Publication
(10) Pub. No.: US 2025/0227014 A1
(43) Pub. Date: Jul. 10, 2025

(54) COMMUNICATION METHOD AND COMMUNICATION APPARATUS

(71) Applicant: HUAWEI TECHNOLOGIES CO., LTD., Shenzhen (CN)

(72) Inventors: Xiaolu WANG, Hangzhou (CN); Chuili KONG, Hangzhou (CN); Feiran ZHAO, Hangzhou (CN); Ruonan YANG, Shenzhen (CN); Rong LI, Boulogne Billancourt (FR)

(21) Appl. No.: 19/090,087

(22) Filed: Mar. 25, 2025

Related U.S. Application Data
(63) Continuation of application No. PCT/CN2023/103453, filed on Jun. 28, 2023.

(30) Foreign Application Priority Data
Sep. 26, 2022 (CN) 202211175283.4

(51) Int. Cl. H04L 27/26

(52) U.S. Cl. CPC H04L 27/2618

(57) ABSTRACT

This application discloses a communication method and a communication apparatus. One example method includes: A terminal device determines, at a first moment, a first TR pattern corresponding to a first beam, and determines, at a second moment, a second TR pattern corresponding to a second beam. The first beam is a serving beam of the terminal device at the first moment, and the second beam is a serving beam of the terminal device at the second moment. The first TR pattern is different from the second TR pattern.

### CROSS-REFERENCE TO RELATED APPLICATIONS

This application is a continuation of International Application No. PCT/CN2023/103453, filed on Jun. 28, 2023, which claims priority to Chinese Patent Application No. 202211175283.4, filed on Sep. 26, 2022. The disclosures of the aforementioned applications are hereby incorporated by reference in their entireties.

### TECHNICAL FIELD

This application relates to the field of communication technologies, and in particular, to a communication method and a communication apparatus.

### BACKGROUND

A tone reservation (tone reservation, TR) technology can be used to suppress a peak-to-average power ratio (peak-to-average power ratio, PAPR) of a waveform. To be specific, a transmit end reserves some subcarriers to carry signals for suppressing the PAPR. A pattern (pattern) formed by subcarrier numbers corresponding to the reserved carriers for suppressing the PAPR is referred to as a TR pattern. It may be understood that reserving some subcarriers reduces spectrum utilization. Currently, when PAPR suppression is performed on a plurality of beams in a cell, TR patterns used by the plurality of beams are the same. However, different beams cover different quantities of terminal devices, and therefore have different requirements for throughput and spectrum utilization. The current PAPR suppression solution cannot meet a throughput requirement of each beam, and has spectrum utilization.

### SUMMARY

This application provides a communication method and a communication apparatus, to meet a throughput requirement of each beam, and improve spectrum utilization.

According to a first aspect, an embodiment of this application provides a communication method. The method may be performed by a first communication apparatus. The first communication apparatus may be a communication device or a communication apparatus that can support the communication device in implementing a function required by the method, for example, a chip system. For example, the communication device is a terminal device, or a chip disposed in a terminal device, or another component configured to implement a function of the terminal device. The following uses an example in which the first communication apparatus is the terminal device for description.

The communication method includes: The terminal device determines, at a first moment, a first TR pattern corresponding to a first beam, and determines, at a second moment, a second TR pattern corresponding to a second beam. The first beam is a serving beam of the terminal device at the first moment, the second beam is a serving beam of the terminal device at the second moment, and the first TR pattern is different from the second TR pattern.

In this embodiment of this application, the first TR pattern and the second TR pattern may be different. To be specific, different beams in a cell may use different TR patterns, and noise interference generated during PAPR suppression is controlled not to be in a beam direction with a wanted signal, to avoid interference between beams and improve system spectrum utilization. In addition, a proper quantity of reserved carriers may be allocated to each beam based on a throughput requirement of each beam, so that each beam can achieve high throughput, spectrum utilization can be improved, and a link budget can be improved.

In a possible implementation, the terminal device sends or receives information through the first beam between the first moment and the second moment, and sends or receives information through the second beam since the second moment. When a serving beam of the terminal device changes, correspondingly, a TR pattern used by the terminal device may also change.

In a possible implementation, that the terminal device determines, at a first moment, a first TR pattern corresponding to a first beam includes: The terminal device receives a mapping relationship from a network device, where the mapping relationship indicates a correspondence between at least one TR pattern and at least one beam; and the terminal device determines the first TR pattern based on the first beam and the mapping relationship. In this solution, the network device may configure, for the terminal device, a TR pattern corresponding to each beam, so that the terminal device may determine, based on configuration of the network device, a TR pattern corresponding to a serving beam, which is more flexible.

In a possible implementation, that the mapping relationship indicates a correspondence between at least one TR pattern and at least one beam includes: The mapping relationship indicates a correspondence between the at least one TR pattern and a beam parameter set. The beam parameter set includes one or more of the following information: a bandwidth part (bandwidth part, BWP), a transmission configuration indicator (transmission configuration indicator, TCI), a synchronization signal block index, or a geographical location range. A specific implementation form of the mapping relationship is not limited in this embodiment of this application. For example, the mapping relationship may be a correspondence between the at least one TR pattern and the BWP, or may be a correspondence between the at least one TR pattern and the geographical location range.

In a possible implementation, that the terminal device determines, at a first moment, a first TR pattern corresponding to a first beam includes: The terminal device receives first configuration information from a network device. The first configuration information includes configuration information of a first beam set, and each beam in the first beam set corresponds to a third TR pattern. If the first beam falls within the first beam set, the terminal device determines that the first TR pattern is the third TR pattern. In this embodiment of this application, the network device may configure, for the terminal device, a beam using a TR pattern. If a serving beam of the terminal device falls within the beam configured by the network device, the terminal device determines to use a TR pattern corresponding to the configured beam.

In a possible implementation, that the terminal device determines, at a first moment, a first TR pattern corresponding to a first beam includes: The terminal device receives second configuration information from the network device, where the second configuration information indicates the first TR pattern corresponding to the first beam and/or a TR pattern corresponding to at least one third beam, and the at least one third beam is a beam adjacent to the first beam; and the terminal device determines the first TR pattern based on the second configuration information. In this embodiment of this application, the network device may configure, for the terminal device, a TR pattern corresponding to the serving beam and a TR pattern corresponding to a beam adjacent to the serving beam, and a TR pattern corresponding to a used beam is not needed. This reduces signaling overheads.

In a possible implementation, the method further includes: The terminal device receives indication information from the network device. The indication information indicates not to suppress a PAPR. For example, the indication information may indicate the terminal device and/or the network device not to suppress the PAPR. Alternatively, the indication information indicates that a TR pattern is associated with a cell; or the indication information indicates that a TR pattern is associated with a beam. In this embodiment of this application, the network device may explicitly indicate, to the terminal device, whether the terminal device uses the TR pattern, or may explicitly indicate, to the terminal device, whether the terminal device uses a cell-level TR pattern or a beam-level TR pattern. If the network device configures the cell-level TR pattern, only one TR pattern needs to be configured for the terminal device, so that signaling overheads can be reduced.

According to a second aspect, an embodiment of this application provides a communication method. The method may be performed by a second communication apparatus. The first communication apparatus may be a communication device or a communication apparatus that can support the communication device in implementing a function required by the method, for example, a chip system. For example, the communication device is a network device, or a chip disposed in a network device, or another component configured to implement a function of a network device. The following uses an example in which the first communication apparatus is a network device for description.

The communication method includes: The network device determines at least one TR pattern corresponding to at least two beams, and indicates, to a terminal device, the at least one TR pattern corresponding to the at least two beams. The at least two beams include a first beam and a second beam, and a first TR pattern corresponding to the first beam is different from a second TR pattern corresponding to the second beam.

In a possible implementation, that the network device indicates, to a terminal device, the at least one TR pattern corresponding to the at least two beams includes: The network device sends a mapping relationship to the terminal device. The mapping relationship indicates a correspondence between at least one TR pattern and at least one beam.

In a possible implementation, that the mapping relationship indicates a correspondence between at least one TR pattern and at least one beam includes: The mapping relationship indicates a correspondence between the at least one TR pattern and a beam parameter set. The beam parameter set includes one or more of the following information: a bandwidth part BWP, a transmission configuration indicator TCI, a synchronization signal block index, or a geographical location range.

In a possible implementation, that the network device indicates, to a terminal device, the at least one TR pattern corresponding to the at least two beams includes: The network device sends first configuration information to the terminal device. The first configuration information includes configuration information of a first beam set.

In a possible implementation, that the network device indicates, to a terminal device, the at least one TR pattern corresponding to the at least two beams includes: The network device sends second configuration information to the terminal device. The second configuration information indicates the first TR pattern corresponding to the first beam and/or a TR pattern corresponding to at least one third beam, and the at least one third beam is a beam adjacent to the first beam.

In a possible implementation, the network device further sends indication information to the terminal device. The indication information indicates not to suppress a PAPR, or the indication information indicates that a TR pattern is associated with a cell, or the indication information indicates that a TR pattern is associated with a beam.

For beneficial effect of the second aspect and the implementations of the second aspect, refer to descriptions of beneficial effect of the first aspect and the implementations of the first aspect.

According to a third aspect, an embodiment of this application provides a communication apparatus. The communication apparatus has a function of implementing behavior in the method embodiment of the first aspect or the second aspect. For beneficial effect, refer to the descriptions of the first aspect. Details are not described herein again.

The communication apparatus may be the communication apparatus in the first aspect, or the communication apparatus may be an apparatus, for example, a chip or a chip system, that can implement the method provided in the first aspect. In a possible design, the communication apparatus includes a corresponding means (means) or module for performing the method in the first aspect. For example, the communication apparatus includes a processing unit (sometimes also referred to as a processing module or a processor) and/or a transceiver unit (sometimes also referred to as a transceiver module or a transceiver). The transceiver unit may include a sending unit and a receiving unit, or it may be understood as that the sending unit and the receiving unit are a same functional module. Alternatively, the transceiver unit is understood as a general term of a sending unit and a receiving unit, and the sending unit and the receiving unit may be different functional modules. These units (modules) may perform a corresponding function in the method example of the first aspect. For details, refer to the detailed descriptions in the method example. Details are not described herein again.

The communication apparatus may be the communication apparatus in the second aspect, or the communication apparatus may be an apparatus, for example, a chip or a chip system, that can implement the method provided in the second aspect. In a possible design, the communication apparatus includes a corresponding means (means) or module for performing the method in the second aspect. For example, the communication apparatus includes a processing unit (sometimes also referred to as a processing module or a processor) and/or a transceiver unit (sometimes also referred to as a transceiver module or a transceiver). The transceiver unit may include a sending unit and a receiving unit, or it may be understood as that the sending unit and the receiving unit are a same functional module. Alternatively, the transceiver unit is understood as a general term of a sending unit and a receiving unit, and the sending unit and the receiving unit may be different functional modules. These units (modules) may perform a corresponding function in the method example of the second aspect. For details, refer to the detailed descriptions in the method example. Details are not described herein again.

According to a fourth aspect, an embodiment of this application provides a communication apparatus. The communication apparatus may be the communication apparatus in the third aspect, or a chip or a chip system disposed in the communication apparatus in the third aspect. The communication apparatus may be a terminal device or a network device. The communication apparatus includes a communication interface and a processor, and optionally, further includes a memory. The memory is configured to store a computer program. The processor is coupled to the memory and the communication interface. When the processor reads the computer program or instructions, the communication apparatus is enabled to perform the method performed by the communication apparatus in the foregoing method.

According to a fifth aspect, an embodiment of this application provides a communication apparatus. The communication apparatus includes an input/output interface and a logical circuit. The input/output interface is configured to input and/or output information. The logical circuit is configured to perform the method according to any one of the first aspect and the second aspect.

According to a sixth aspect, an embodiment of this application provides a chip system. The chip system includes a processor, and may further include a communication interface, configured to implement the method according to any one of the first aspect and the second aspect. In a possible implementation, the chip system further includes a memory, configured to store a computer program. The chip system may include a chip, or may include a chip and another discrete component.

According to a seventh aspect, an embodiment of this application provides a communication system. The communication system includes a terminal device and a network device that are configured to implement related functions in any one of the first aspect and the second aspect. Certainly, the communication system may include more terminal devices or more network devices.

According to an eighth aspect, this application provides a computer-readable storage medium. The computer-readable storage medium stores a computer program. When the computer program is run, the method according to any one of the first aspect and the second aspect is implemented.

According to a ninth aspect, a computer program product is provided. The computer program product includes computer program code. When the computer program code is run, the method according to any one of the first aspect and the second aspect is performed.

For beneficial effect of the second aspect to the ninth aspect and the implementations of the second aspect to the ninth aspect, refer to the descriptions of the beneficial effect of the first aspect and the implementations of the first aspect.

### BRIEF DESCRIPTION OF DRAWINGS

FIG. 1 is a diagram of an architecture of a communication system to which an embodiment of this application is applicable;

FIG. 2 is a diagram of an architecture of another communication system to which an embodiment of this application is applicable;

FIG. 3 is a diagram of a network architecture of still another communication system to which an embodiment of this application is applicable;

FIG. 4 is a diagram of a multi-beam PAPR suppression according to an embodiment of this application;

FIG. 5 is a schematic flowchart of a communication method according to an embodiment of this application;

FIG. 6 is a diagram of a multi-beam PAPR suppression according to an embodiment of this application;

FIG. 7 is a diagram of controlling a TR noise transmission direction according to an embodiment of this application;

FIG. 8 is another diagram of controlling a TR noise transmission direction according to an embodiment of this application;

FIG. 9 is a diagram of a plurality of beams in one cell according to an embodiment of this application;

FIG. 10 is a block diagram of a principle of multi-beam PAPR suppression according to an embodiment of this application;

FIG. 11 is a diagram of PAPR suppression effect achieved by using a solution according to an embodiment of this application;

FIG. 12 is a diagram of coverage of two satellites according to an embodiment of this application;

FIG. 13 is a diagram of a structure of a communication apparatus according to an embodiment of this application; and

FIG. 14 is a diagram of another structure of a communication apparatus according to an embodiment of this application.

### DESCRIPTION OF EMBODIMENTS

Technical solutions provided in embodiments of this application may be applied to a new radio (new radio, NR) system, a long term evolution (long term evolution, LTE) system, and a non-terrestrial network (non-terrestrial network, NTN) system, or may be further applied to a next generation mobile communication system or another similar communication system. The technical solutions provided in embodiments of this application may also be applied to a vehicle to everything (vehicle to everything, V2X) system, an Internet of Things (Internet of Things, IoT) system, and the like.

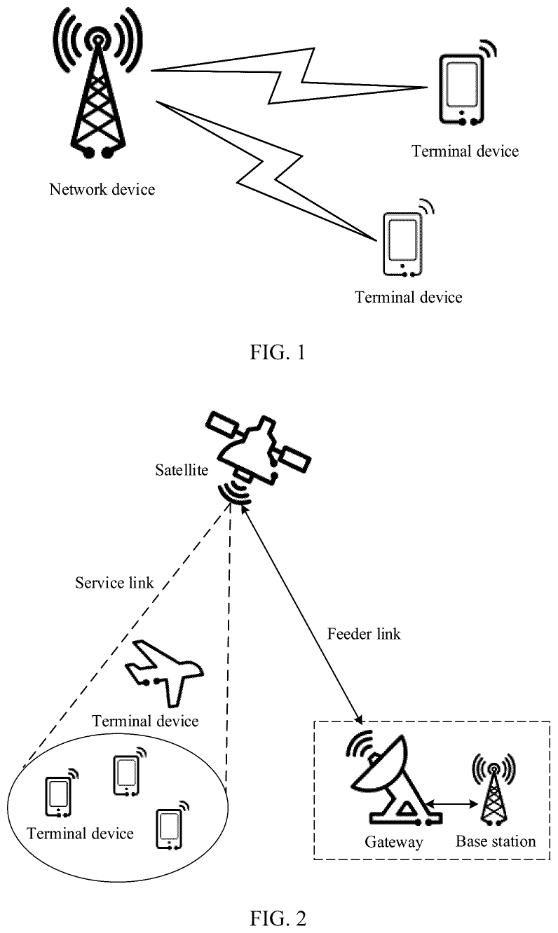

In an example, FIG. 1 is a diagram of a network architecture of a communication system to which an embodiment of this application is applicable. The communication system may include a network device and two terminal devices. The two terminal devices may be mobile terminal devices and/or any other suitable devices used for communication in a wireless communication system, and may be both connected to the network device. Both the two terminal devices can communicate with the network device. Certainly, a quantity of terminal devices in FIG. 1 is merely an example. There may be fewer or more terminal devices.

In embodiments of this application, the terminal device is a device having a wireless transceiver function, and may send a signal to the network device, or receive a signal from the network device. The terminal device may include user equipment (user equipment, UE), and is sometimes referred to as a terminal, an access station, a UE station, a remote station, a wireless communication device, a user apparatus, or the like. The terminal device is configured to connect a person, an object, a machine, and the like, may be widely used in various scenarios, and includes, for example, but not limited to terminal devices in the following scenarios: cellular communication, device to device (device to device, D2D), V2X, machine-to-machine/machine-type communication (machine-to-machine/machine-type communication, M2M/MTC), IoT, virtual reality (virtual reality, VR), augmented reality (augmented reality, AR), industrial control (industrial control), self driving (self driving), remote medical (remote medical), a smart grid (smart grid), smart furniture, a smart office, a smart wearable, smart transportation, a smart city (smart city), an unmanned aerial vehicle, and a robot.

By way of example rather than limitation, in embodiments of this application, the terminal device may alternatively be a wearable device. The wearable device may also be referred to as a wearable intelligent device, an intelligent wearable device, or the like, and is a general term of wearable devices that are intelligently designed and developed for daily wear by using a wearable technology, for example, glasses, gloves, watches, clothes, and shoes. If the various terminal devices described above are located in a vehicle (for example, placed in the vehicle or mounted in the vehicle), the terminal devices may be all considered as vehicle-mounted terminal devices. For example, the vehicle-mounted terminal device is also referred to as an on-board unit (on-board unit, OBU). The terminal device in this application may alternatively be a vehicle-mounted module, a vehicle-mounted assembly, a vehicle-mounted component, a vehicle-mounted chip, or an on-board unit that is built in a vehicle as one or more components or units. The vehicle uses the vehicle-mounted module, the vehicle-mounted assembly, the vehicle-mounted component, the vehicle-mounted chip, or the on-board unit that is built in the vehicle, to implement a method in this application.

In embodiments of this application, a communication apparatus configured to implement a function of the terminal device may be the terminal device, or may be an apparatus, for example, a chip system, that can support the terminal device in implementing the function. The apparatus may be mounted in the terminal device. In the technical solutions provided in embodiments of this application, the technical solutions provided in embodiments of this application are described by using an example in which the apparatus configured to implement the function of the terminal device is the terminal device.

In embodiments of this application, the network device may be an access device through which the terminal device accesses a mobile communication system in a wireless manner, for example, includes an access network (access network, AN) device, for example, a base station. The network device may alternatively be a device that communicates with the terminal device through an air interface. The network device may include an evolved NodeB (evolved NodeB, eNB/e-NodeB) in an LTE system or a long term evolution-advanced (long term evolution-advanced, LTE-A) system. The network device may alternatively include a next generation NodeB (next generation NodeB, gNB) in an NR system. The network device may alternatively include an access node or the like in a wireless-fidelity (wireless-fidelity, Wi-Fi) system. The network device may alternatively be a station (station), a relay station, a vehicle-mounted device, a future evolved public land mobile network (Public Land Mobile Network, PLMN) device, a device in a D2D network, a device in an M2M network, a device in an Internet of Things IoT network, a network device in a PLMN network, or the like. A specific technology and a specific device form that are used for the network device are not limited in embodiments of this application.

In addition, the base station in embodiments of this application may include a central unit (central unit, CU) and a distributed unit (distributed unit, DU), and a plurality of DUs may be centrally controlled by one CU. The CU and the DU may be divided based on a protocol layer function that the CU and the DU each have in a wireless network. For example, functions of a packet data convergence protocol (packet data convergence protocol, PDCP) layer and a protocol layer above the packet data convergence protocol layer are set on the CU, and functions of protocol layers below the PDCP layer, for example, a radio link control (radio link control, RLC) layer and a medium access control (medium access control, MAC) layer, are set on the DU. It should be noted that such protocol layer division is merely an example, and division may be performed at another protocol layer. A radio frequency apparatus may be remotely deployed and not placed in the DU, or may be integrated into the DU, or may be partially remotely disposed and partially integrated into the DU. This is not limited in embodiments of this application. In addition, in some embodiments, a control plane (control plane, CP) and a user plane (user plane, UP) of the CU may be separated into different entities for implementation, where the entities are respectively a control-plane CU entity (CU-CP entity) and a user-plane CU entity (CU-UP entity). The control plane CU-CP of the CU further includes a further division architecture. In other words, an existing CU-CP is further divided into a CU-CP 1 and a CU-CP 2. The CU-CP 1 includes various radio resource management functions, and the CU-CP 2 includes only a radio resource control (radio resource control, RRC) function and a PDCP-C function (that is, a basic function of control plane signaling at the PDCP layer).

In embodiments of this application, a communication apparatus configured to implement a function of a network device or a terminal device may be a network device or a terminal device, or may be an apparatus that can support the network device or the terminal device in implementing the function, for example, a chip system. The apparatus may be mounted in the network device or the terminal device. In the technical solutions provided in embodiments of this application, the technical solutions provided in embodiments of this application are described by using an example in which an apparatus configured to implement the function of the network device is a network device and an apparatus configured to implement the function of the terminal device is a terminal device.

In another example, FIG. 2 is a diagram of a network architecture of another communication system to which an embodiment of this application is applicable. The communication system includes a satellite, a terminal device, and a gateway. The satellite may be a highly elliptical orbiting (highly elliptical orbiting, HEO) satellite, a geostationary earth orbit (geosynchronous earth orbit, GEO) satellite, a medium earth orbit (medium earth orbit, MEO) satellite, and a low-earth orbit (low-earth orbit, LEO) satellite. In addition, an NTN system may further include a high altitude platform (high altitude platform station, HAPS) and the like. This is not limited herein. The gateway (or referred to as a ground station, an earth station, a signal gateway station, or a gateway station) (gateway) may be configured to connect the satellite and a terrestrial base station. One or more satellites may be connected to one or more terrestrial base stations via one or more gateways. This is not limited herein. The terminal device includes, for example, mobile phones, an airplane, and the like (which are used as an example in FIG. 2). A link between the satellite and the terminal device is referred to as a service link (service link), and a link between the satellite and the gateway is referred to as a feeder link (feeder link).

An operating mode of the satellite is not limited in embodiments of this application. For example, the operating mode of the satellite may be a transparent (transparent) transmission mode, or a regenerative (regenerative) mode.

In the transparent transmission mode, the satellite, as an analog radio frequency repeater, has a relay forwarding function, can implement radio frequency conversion and amplification, and can transparently transmit or copy a signal between the base station and the terminal device. For example, a signal sent by the terminal device may be transparently transmitted via the satellite and forwarded by the gateway to the terrestrial base station. The gateway has some or all functions of the base station. In this case, the gateway may be considered as a base station. It may be considered as that the gateway and the base station may be deployed together or separately. If the gateway and the base station are separately deployed, a delay of the feeder link includes a delay from the satellite to the gateway and a delay from the gateway to the base station.

In the regenerative mode, the satellite, as a base station for wireless communication, has some or all functions of the base station, implements regeneration of signals received from the ground, and may understand and process these signals. For example, the satellite may be a base station carried on an artificial earth satellite or a high-altitude aircraft. For example, the base station may be an evolved NodeB (eNB) or a 5G base station (gNB). The gateway may forward signaling between the satellite (namely, the base station) and a core network.

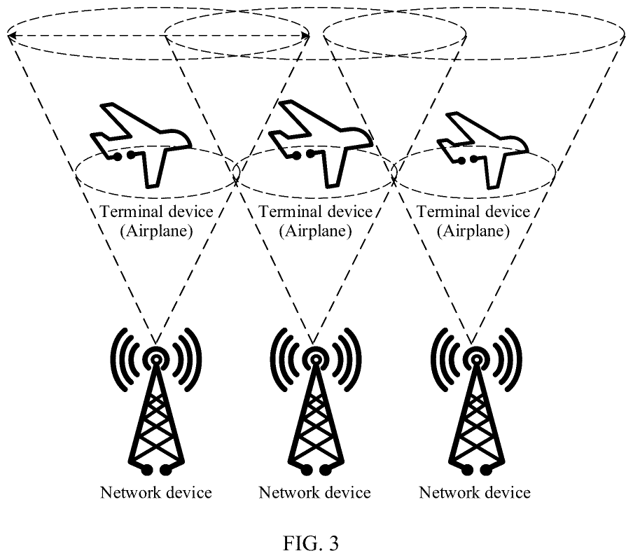

It may be understood that embodiments of this application are also applicable to an air-to-ground (air-to-ground, ATG) communication system. For example, FIG. 3 is a diagram of a network architecture of still another communication system to which an embodiment of this application is applicable. The communication system includes at least one network device and at least one high-altitude terminal device, for example, a high-altitude airplane and an on-board terminal device.

In embodiments of this application, unless otherwise specified, a quantity of a noun indicates “a singular noun or a plural noun”, namely, “one or more”. “At least one” means one or more, and “a plurality of” means two or more. “And/or” describes an association relationship between associated objects and indicates that three relationships may exist. For example, A and/or B may indicate the following three cases: Only A exists, both A and B exist, and only B exists, where A and B may be singular or plural. The character “/” generally indicates an “or” relationship between the associated objects. For example, A/B indicates A or B. “At least one of the following items (pieces)” or a similar expression thereof indicates any combination of these items, including a single item (piece) or any combination of a plurality of items (pieces). For example, at least one of a, b, or c indicates a, b, c, a and b, a and c, b and c, or a, b, and c, where a, b, and c may be singular or plural.

Ordinal numerals such as “first” and “second” in embodiments of this application are used to distinguish between a plurality of objects, and are not intended to limit sizes, content, a sequence, a time sequence, application scenarios, priorities, or importance of the plurality of objects. For example, “a first beam” and “a second beam” indicate that there are two beams, but do not indicate that the two beams have different priorities, importance degrees, or the like.

The foregoing describes the communication systems to which embodiments of this application are applicable. The following describes related technical content mainly related to embodiments of this application.

A satellite data processing capability and transmit power of a satellite device are limited due to manufacturing and transmission costs. Specifically, the satellite device is an energy- and power-limited device, and is sensitive to satellite power efficiency, that is, power efficiency of the satellite device is expected to be improved as much as possible. In both terrestrial cellular network communication and NTN communication, it is required that a high power amplifier (high power amplifier, HPA) at a transmit end operates near a linear saturation region, to improve power efficiency of the HPA.

If a system performs data transmission through an orthogonal frequency division multiplexing (orthogonal frequency division multiplexing, OFDM) waveform or a waveform with a high PAPR characteristic, a high PAPR occurs. Because a PAPR of an OFDM signal is high, when the HPA operates near a saturation point, there is a specific probability that the signal that is input to the HPA enters a non-linear region, and therefore non-linear distortion occurs. The non-linear distortion introduces in-band distortion and out-of-band radiation, which affects decoding accuracy of a receive end and causes interference to a user on an adjacent channel. Therefore, power back-off can be performed on the signal that is input to the HPA, to minimize non-linear distortion of the HPA. Performing power back-off on the signal that is input to the HPA may be understood as reducing power of the signal that is input to the HPA. Although power back-off performed on the signal that is input to the HPA may reduce non-linear distortion of the HPA, power of a signal output by the HPA is reduced. This reduces transmit power and power efficiency of the HPA, and further reduces signal receiving power of the receive end and reduces a signal-to-noise ratio of the receive end. Therefore, a TR technology is proposed to suppress the PAPR corresponding to the OFDM waveform. The TR technology may be understood as reserving some reserved carriers as carriers for suppressing the PAPR, and the reserved carriers carry signals or energy for suppressing the PAPR. The reserved carrier used to suppress the PAPR may include a plurality of subcarriers, or a set including these subcarriers may be referred to as a carrier set. A pattern (pattern) including subcarrier numbers corresponding to subcarriers included in the carrier set is referred to as a TR pattern (TR pattern), that is, the TR pattern may indicate a set of reserved carriers used to suppress the PAPR.

It may be understood that, the reserved carriers for suppressing the PAPR are reserved at a transmit end to carry a signal for suppressing the PAPR, and some carriers other than the reserved carriers are used to carry a data signal. Certainly, to improve spectral efficiency, a data signal may also be carried on the reserved carrier, that is, the reserved carrier may carry both the signal for suppressing the PAPR and the data signal. Optionally, a carrier set carrying the signal for suppressing the PAPR does not overlap a carrier set carrying the data signal (this is used as an example in this specification). When demodulating information received from the transmit end, the receive end may skip or remove the reserved carriers for suppressing the PAPR, that is, may not decode the signals on the reserved carriers for suppressing the PAPR. A principle of PAPR suppression based on the TR pattern is the conventional technology, and details are not described herein.

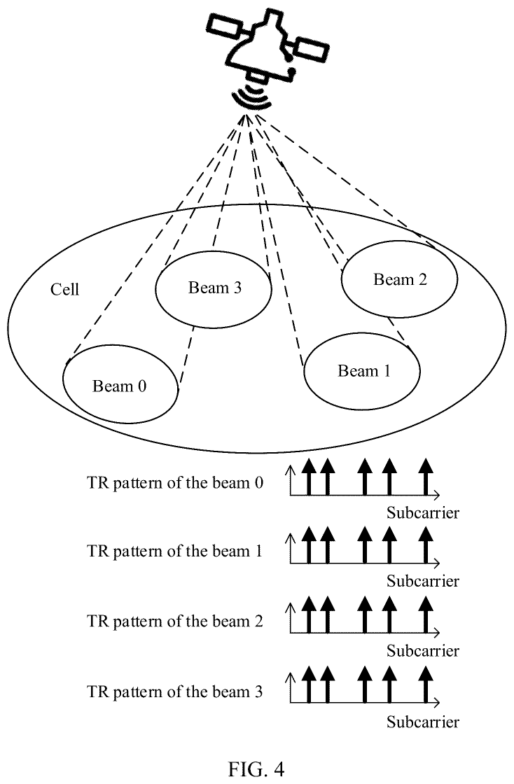

When PAPR suppression is performed on a plurality of beams in a cell, to avoid interference caused by noise generated during PAPR suppression, the plurality of beams use a same TR pattern, that is, a same subcarrier needs to be reserved for the plurality of beams. For example, FIG. 4 is a diagram of a multi-beam PAPR suppression. In FIG. 4, four beams (namely, a beam 0 to a beam 3) are used as an example. The beam 0 to the beam 3 use a same TR pattern. If the plurality of beams use the same TR pattern, system frequency utilization decreases. For example, for bandwidth of 200 M, when a subcarrier spacing is 120 kHz, the TR pattern occupies 88 subcarriers, and one beam loses 88/1584=5.56% spectrum, that is, 5.56% spectrum is lost in the cell.

In addition, quantities of users and user density in coverage areas of different beams are different. When there are a large quantity of users in a coverage area of a beam or some beams, the coverage area is required to have higher throughput and higher spectrum utilization. However, when PAPR suppression is performed on a multi-beam signal, a part of subcarriers still need to be reserved for a beam with high throughput. To be specific, no data transmission reduces spectrum utilization of the beam. It can be learned that when the plurality of beams use the same TR pattern, high throughput of each beam cannot be met.

In embodiments of this application, different beams in a cell may use different TR patterns, so that system spectrum utilization can be improved. In addition, a proper quantity of reserved carriers may be allocated to each beam based on a throughput requirement of each beam, so that each beam can achieve high throughput, spectrum utilization can be improved, and a link budget can be improved.

The technical solutions provided in embodiments of this application are described below in detail with reference to accompanying drawings.

A communication method provided in embodiments of this application may be applied to any communication system, provided that a transmit end communicates with a receive end. In the following descriptions, the communication method is applied to any communication system shown in FIG. 1 to FIG. 3. The communication method provided in embodiments of this application may be applied to uplink transmission, or applied to downlink transmission. It should be understood that uplink transmission and downlink transmission are relative. For example, if transmission from a first communication apparatus to a second communication apparatus is the uplink transmission, transmission from the second communication apparatus to the first communication apparatus is the downlink transmission. Embodiments of this application are not limited to performing data transmission through an OFDM waveform. For example, data transmission may alternatively be performed through a DFT-S-OFDM waveform. That is, DFT precoding is first performed on data, and then data obtained through precoding is mapped to a frequency domain data subcarrier.

A type of a reference signal is not limited in embodiments of this application. For example, the reference signal may be a phase tracking reference signal (phase tracking reference signal, PTRS), a demodulation reference signal (demodulation reference signal, DMRS), a channel state information-reference signal (channel state information-reference signal, CSI-RS), a tracking reference signal (tracking reference signal, TRS), or a sounding reference signal (sounding reference signal, SRS). In the following descriptions, “when” and “in a case of” belong to a same concept, and may be interchangeable unless otherwise specified.

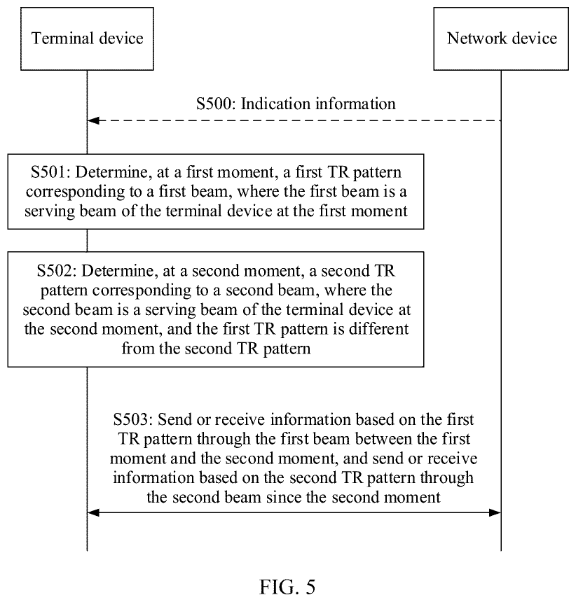

FIG. 5 is a schematic flowchart of a communication method according to an embodiment of this application. In the following descriptions, an example in which the communication method is performed by a terminal device and a network device is used. The network device may be a satellite.

S501: The terminal device determines, at a first moment, a first TR pattern corresponding to a first beam, where the first beam is a serving beam of the terminal device at the first moment.

S502: The terminal device determines, at a second moment, a second TR pattern corresponding to a second beam, where the second beam is a serving beam of the terminal device at the second moment, and the first TR pattern is different from the second TR pattern.

As the terminal device moves or the network device moves, serving beams of the terminal device may be different at different moments. If the terminal device determines to send or receive information by using TR, the terminal device may determine, at a current moment, a TR pattern corresponding to a serving beam. For example, the terminal device determines, at the first moment, the first TR pattern corresponding to the first beam, and determines, at the second moment, the second TR pattern corresponding to the second beam. The first beam is the serving beam of the terminal device at the first moment, and the second beam is the serving beam of the terminal device at the second moment. When the terminal device switches from the first beam to the second beam, the terminal device sends or receives information based on the first TR pattern through the first beam between the first moment and the second moment, and sends or receives information based on the second TR pattern through the second beam since the second moment.

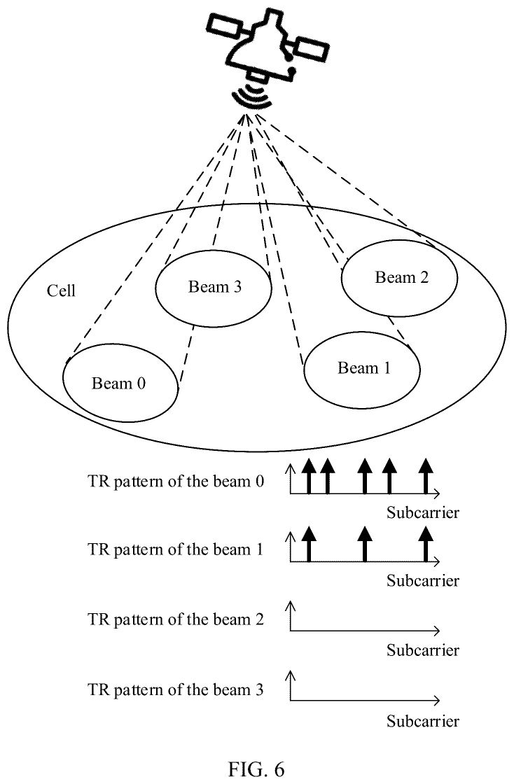

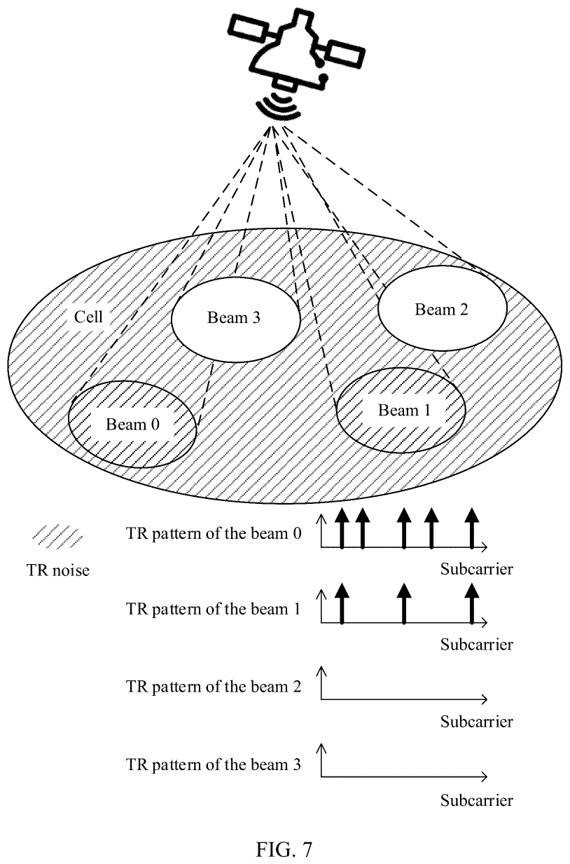

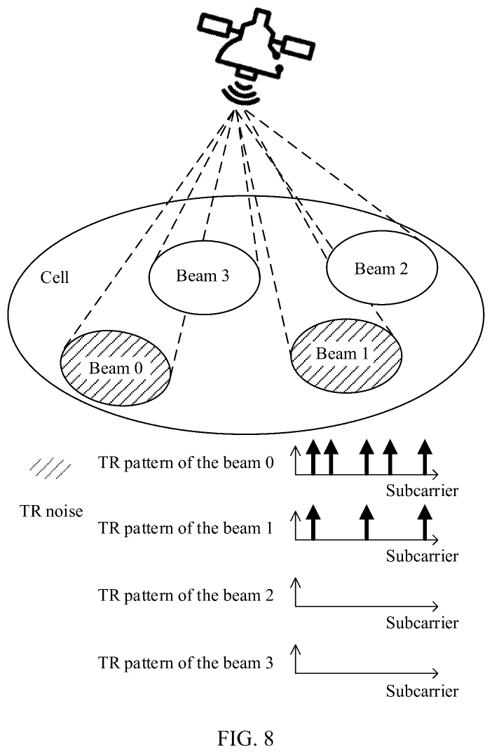

In this embodiment of this application, the first TR pattern and the second TR pattern may be different, that is, different beams in a cell may use different TR patterns. In other words, there is no need to reserve a same subcarrier for all beams. For example, FIG. 6 is a diagram of a multi-beam PAPR suppression. In FIG. 6, four beams (namely, a beam 0 to a beam 3) are used as an example. The beam 0 and the beam 1 use different TR patterns, and the beam 2 and the beam 3 do not use reserved carriers. It can be learned from FIG. 6 and FIG. 4 that when different beams use different TR patterns, system frequency utilization can be improved. In this case, noise interference generated during PAPR suppression is controlled not to be in a beam direction with a wanted signal, to avoid interference between beams. The example in FIG. 6 is still used. The network device and/or the terminal device control/controls a transmit direction of interference noise generated by the TR to not point to a direction of the beam 2 and a direction of the beam 3 that have no reserved carrier. TR noise in the beam 0 and the beam 1 is also distributed on only the reserved carriers, and does not interfere with data sending and receiving. For example, as shown in FIG. 7, TR noise may be controlled not to point to the beam 2 and the beam 3 that have no reserved carrier, and TR noise exists in another direction or coverage area. For another example, as shown in FIG. 8, the TR noise may point to only the beam 0 and the beam 1 that have a reserved carrier, that is, the TR noise generated during PAPR suppression is distributed on only the reserved carriers.

In addition, different beams use different TR patterns, and a proper quantity of reserved carriers may be allocated to each beam based on a throughput requirement of each beam, so that each beam can achieve high throughput, spectrum utilization can be improved, and a link budget can be improved. For example, a small quantity of subcarriers may be reserved for a beam with a high throughput requirement, and a large quantity of subcarriers may be reserved for a beam with a low throughput requirement, so that each beam can achieve high throughput.

That the terminal device determines the TR pattern based on the beam may be understood as that the terminal device uses a beam-level TR pattern, or it may be considered as that the TR pattern is associated with a beam, or the terminal device uses a beam-level TR solution. Correspondingly, if all beams in a cell use a same TR pattern, it may be understood as that the terminal device uses a cell-level TR pattern, or the TR pattern is associated with the cell.

In a possible implementation, the network device may indicate, to the terminal device, whether to use a TR solution, whether to use the cell-level TR solution, or whether to use a beam-level TR solution. For example, the network device may perform S500.

S500: The network device sends indication information to the terminal device, and correspondingly, the terminal device receives the indication information sent by the network device. The indication information may indicate not to suppress a PAPR, or the indication information may indicate that the TR pattern is associated with the cell, or the indication information may indicate that the TR pattern is associated with the beam.

That the indication information indicates not to suppress the PAPR includes that the indication information indicates the terminal device and/or the network device not to suppress the PAPR. In other words, the indication information may indicate the terminal device and/or the network device not to use the TR solution. That the indication information indicates that the TR pattern is associated with the cell may also be understood as that the indication information indicates to use the cell-level TR solution. If the indication information indicates the terminal device to use the cell-level TR solution, the network device may configure a TR pattern for the terminal device, to reduce signaling overheads. That the indication information indicates that the TR pattern is associated with the beam may also be understood as that the indication information indicates to use the beam-level TR solution. If the indication information indicates the terminal device to use the beam-level TR solution, the network device further indicates, to the terminal device, a TR pattern corresponding to each beam.

The indication information may be carried in system information. For example, the indication information may be carried in a master information block (master information block, MIB) message or a PBCH payload message.

If the network device indicates, to the terminal device, the TR pattern corresponding to each beam, it may also be considered as that the network device indicates, to the terminal device, the terminal device to use the beam-level TR solution. In this case, the network device does not need to indicate, by using the indication information, the terminal device to use the beam-level TR solution. Therefore, S500 is not necessarily performed, and is represented by using a dashed line in FIG. 5. If the network device does not indicate the TR pattern corresponding to each beam to the terminal device, or the network device does not configure the TR pattern for the terminal device, the terminal device may not use the beam-level TR solution or not use the TR solution to suppress the PAPR by default. If the network device configures a TR pattern for the terminal device, the terminal device may use the cell-level TR pattern by default. Alternatively, it may be considered as that the network device may implicitly indicate the cell-level TR solution or the beam-level TR solution to the terminal device.

The network device implicitly indicates, to the terminal device, the TR pattern corresponding to each beam, including but not limited to the following several manners. A specific indication manner is not limited in embodiments of this application.

Indication manner 1: The network device sends a mapping relationship to the terminal device. The mapping relationship indicates a correspondence between at least one TR pattern and at least one beam. In the indication manner, the terminal device determines the first TR pattern at the first moment based on the first beam and the mapping relationship. In a possible implementation, the mapping relationship is preconfigured, predefined, or agreed on. If the network device sends the mapping relationship to the terminal device, the network device may indicate the terminal device to use the beam-level TR solution, and further indicate, to the terminal device, a TR pattern used by the terminal device.

For example, the mapping relationship may indicate a correspondence between the at least one TR pattern and a beam parameter set. A beam parameter may indicate a beam. For example, the beam parameter may include a beam index, a BWP, a TCI, a synchronization signal, a physical broadcast channel (physical broadcast channel, PBCH) block (synchronization signal and PBCH block, SSB), or a geographical location range. That is, the beam parameter set includes one or more of the following information: the beam index, the BWP, the TCI, a synchronization signal block index, or the geographical location range. Because a beam is mapped to the BWP, the TCI, the SSB, or the geographical location range, beams may be distinguished based on the BWP, the TCI, the SSB, or the geographical location range. A corresponding beam between the terminal device and the network device may be determined based on a BWP number, a TCI number, or an SSB number. It should be noted that the beam described in this application may alternatively be replaced with the BWP, the TCI, or the SSB.

That the beam parameter is an SSB index is used as an example. The mapping relationship may be a correspondence between at least one TR pattern and at least one SSB. The terminal device may determine the first TR pattern at the first moment based on an index of the first beam and the mapping relationship. Alternatively, the mapping relationship may be a correspondence between at least one TR pattern and at least one SSB index (index). The terminal device may determine the first TR pattern at the first moment based on the mapping relationship and an index of an SSB that forms the first beam.

For example, a plurality of TR patterns may be predefined, and different TR patterns correspond to different indexes. For example, when a TR pattern index 0 indicates that a corresponding beam does not use a reserved carrier, or a TR pattern is an empty set Ø, or when a TR pattern is an empty set, it indicates that the network device and the terminal device do not use the TR solution within a coverage area of the beam. A subcarrier sequence number set represented by a TR pattern index 1 is {1 6 10 12}, a subcarrier sequence number set represented by a TR pattern index 2 is {1 6 10 12 15}, and a subcarrier sequence number set represented by a TR pattern index 3 is {1 6 10 12 15 19}. The network device may send a TR pattern index (pattern index) and an SSB index to the terminal device. A correspondence between the TR pattern index and the SSB index may be agreed on. For example, Table 1 shows a mapping relationship between the TR pattern index and the SSB index. It is assumed that the network device sends TR pattern indexes {3, 2, 2, 1, 0, 0, 0, 0} and SSB indexes {0 to 7} to the terminal device. When the index of the first beam of the terminal device at the first moment is 2, the first TR pattern is {1 6 10 12 15}.

TABLE 1

| SSB index (or beam number) | TR pattern index |
|---|---|
| SSB 0 (or beam 0) | TR pattern 2 |
| SSB 1 (or beam 1) | TR pattern 0 |
| . . . | . . . |
| SSB n (or beam n) | TR pattern n |

Indication manner 2: The network device sends first configuration information to the terminal device. The first configuration information includes configuration information of a first beam set. In this indication manner, if the first beam set includes a serving beam of the terminal device, the TR pattern used by the terminal device is a TR pattern corresponding to each beam in the first beam set. For example, the first beam falls within the first beam set, each beam in the first beam set corresponds to a third TR pattern, and the terminal device determines that the first TR pattern is the third TR pattern at the first moment. In this indication manner, the network device configures less content, so that signaling overheads can be reduced.

In a possible implementation, it may be agreed that beams using the TR solution use a same TR pattern, and the TR pattern is predefined, preconfigured, or configured. For example, a beam using the TR solution and a beam not using the TR solution may be distinguished based on beam indexes. For example, beams 0 to 31 are agreed to use the TR, beams 32 to 63 are agreed to not use the TR, and the third TR pattern is predefined, preconfigured, or configured.

In this case, the network device may configure the beam using the TR solution. For example, a set including beams using the TR solution is the first beam set, and the network device may send the configuration information of the first beam set (referred to as the first configuration information in this specification) to the terminal device. If the serving beam of the terminal device falls within the first beam set, the terminal device determines that the used TR pattern is a TR pattern corresponding to the first beam set. For example, the third TR pattern, that is, a TR pattern corresponding to each beam in the first beam set, may be agreed on, preconfigured, or configured. A beam of the terminal device at the first moment is the first beam. If the first beam falls within the first beam set, the terminal device determines, at the first moment, that the first TR pattern corresponding to the first beam is the third TR pattern.

For example, the network device sends beam indexes {0, 1, 2, 3} to the terminal device, which indicates that beams whose indexes are 0, 1, 2, and 3 use the TR solution, and beams that are not included do not use the TR solution.

Alternatively, the network device may configure the beam not using the TR solution. For example, a set including beams not using the TR solution is a second beam set, and the network device may send configuration information of the second beam set to the terminal device. If the serving beam of the terminal device does not fall within the second beam set, the terminal device determines that the used TR pattern is a predefined or preconfigured TR pattern. For example, the third TR pattern may be agreed on, preconfigured, or configured, and the beam of the terminal device at the first moment is the first beam. If the first beam does not fall within the second beam set, the terminal device determines, at the first moment, that the first TR pattern corresponding to the first beam is the third TR pattern.

Alternatively, the network device may configure the beam using the TR solution and the beam not using the TR solution. For example, a set of beams using the TR solution is the first beam set, and a set of beams not using the TR solution is the second beam set. Each beam in the first beam set corresponds to the third TR pattern. The beam of the terminal device at the first moment is the first beam. If the first beam falls within the first beam set, the terminal device determines, at the first moment, that the first TR pattern corresponding to the first beam is the third TR pattern.

For example, the network device indicates, in a bit map manner, the beam using the TR solution. For example, the network device sends {1, 1, 1, 1, 0, 0, 0, 0} which correspond to beam indexes 0 to 8 to the terminal device, to indicate whether the beams 0 to 8 use the TR. “1” indicates that the TR solution is used, and “0” indicates that the TR solution is not used. To be specific, beams whose indexes are 0, 1, 2, and 3 use the TR solution, and beams whose indexes are 4, 5, 6, and 7 do not use the TR solution. For example, it is predefined that a TR pattern used by the beam using the TR solution is a TR pattern 1, and the TR pattern index 0 indicates that a corresponding beam does not use a reserved carrier. In this case, a mapping relationship between the beams 0 to 8 and a TR pattern is shown in Table 2.

TABLE 2

| SSB index (or beam number) | TR pattern index |
|---|---|
| SSB 0 (or beam 0) | TR pattern 1 |
| SSB 1 (or beam 1) | TR pattern 1 |
| SSB 2 (or beam 2) | TR pattern 1 |
| SSB 3 (or beam 3) | TR pattern 1 |
| SSB 4 (or beam 4) | TR pattern 0 |
| SSB 5 (or beam 5) | TR pattern 0 |
| SSB 6 (or beam 6) | TR pattern 0 |
| SSB 7 (or beam 7) | TR pattern 0 |

Optionally, the network device may send the first configuration information to the terminal device in an initial access phase of the terminal device, or may send the first configuration information to the terminal device after the terminal device receives a system information block (system information block, SIB). In this way, after receiving the SSB and before receiving the SIB, the terminal device may determine whether the serving beam uses the TR.

Indication manner 3: A basic TR pattern may be predefined or preconfigured, and the network device may indicate, by indicating an increment on the basic TR pattern, a TR pattern used by each beam. For example, the network device may send configuration information of at least one beam to the terminal device. The configuration information includes information about the at least one beam and an increment corresponding to the at least one beam.

For example, a set including sequence numbers of subcarriers included in the basic TR pattern is {1 6 10 12}. The network device sends beam indexes 1 and 2 and increments {8 9} and {78} corresponding to the two beams to the terminal device. The terminal device may determine that a TR pattern corresponding to the beam 1 is {1 6 10 12 8 9}, and a TR pattern corresponding to the beam 2 is {1 6 10 12 78}.

Indication manner 4: A basic TR pattern may be predefined or preconfigured, and the network device may indicate, by indicating a decrement on the basic TR pattern, a TR pattern used by each beam. For example, the network device may send configuration information of at least one beam to the terminal device. The configuration information includes information about the at least one beam and a decrement corresponding to the at least one beam.

For example, a set including sequence numbers of subcarriers included in the basic TR pattern is {1 6 10 12}. The network device sends beam indexes 1 and 2 and decrements {6} and {6 10} corresponding to the two beams to the terminal device. The terminal device may determine that a TR pattern corresponding to the beam 1 is {1 10 12}, and a TR pattern corresponding to the beam 2 is {1 12}.

Indication manner 5: A basic TR pattern may be predefined or preconfigured, and the network device indicates a beam to select some subcarriers in the basic TR pattern as reserved carriers. For example, the network device indicates the beam 1 to use the first 55 subcarriers of the basic TR pattern, and the beam 2 to use the first 65 subcarriers of the basic TR pattern; or indicates the beam 3 to use subcarriers 14 to 70 of the basic TR pattern.

Optionally, a subcarrier indicated by the basic TR pattern may be a frequency band in which a beam is located or a subcarrier included in a BWP.

Indication manner 6: The network device may indicate, to the terminal device on each beam, a TR pattern corresponding to the beam and a TR pattern corresponding to a beam adjacent to the beam. If coverage areas of two beams overlap, or coverage areas of two beams are adjacent, the two beams are adjacent.

The first beam is used as an example. The network device may send second configuration information to the terminal device. The second configuration information may indicate the first TR pattern corresponding to the first beam and a TR pattern corresponding to at least one third beam. The terminal device determines, at the first moment based on the second configuration information, that the TR pattern corresponding to the first beam is the first TR pattern. When switching from the serving beam to a beam adjacent to the serving beam, the terminal device may determine a to-be-used TR pattern based on a TR pattern that corresponds to the adjacent beam and that is indicated by the network device. For example, the second beam is adjacent to the first beam, that is, the at least one third beam may include the second beam. The terminal device may determine, at the second moment, that a TR pattern corresponding to the second beam in the at least one third beam is the second TR pattern. For a manner in which the network device indicates, to the terminal device on each beam, the TR pattern corresponding to the beam and the TR pattern corresponding to the beam adjacent to the beam, refer to any indication manner in the foregoing indication manner 1 to indication manner 5. In the indication manner 6, the network device does not need to broadcast TR patterns of all beams in a cell, so that signaling overheads can be reduced.

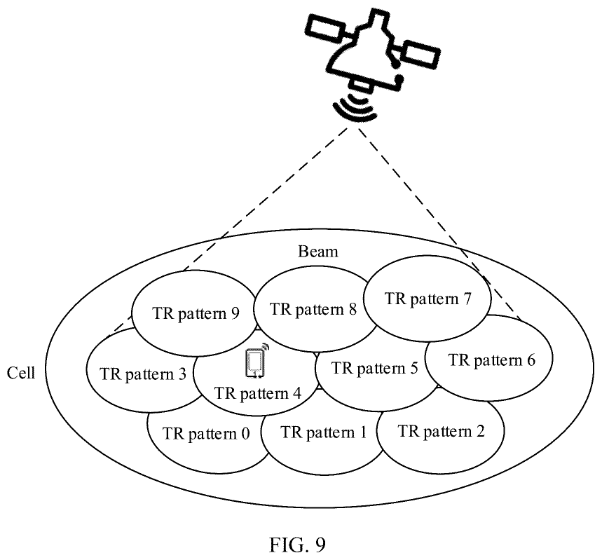

For example, FIG. 9 is a diagram of a plurality of beams in one cell. It is assumed that a current serving beam of the terminal device is the first beam, and a first TR pattern corresponding to the first beam is a TR pattern 4. TR patterns corresponding to a plurality of beams adjacent to the first beam include a TR pattern 0, a TR pattern 1, a TR pattern 3, a TR pattern 5, a TR pattern 8, and a TR pattern 9. The TR pattern 5 corresponds to the second beam. When the terminal device switches from the first beam to the second beam, the terminal device may determine that the second TR pattern is the TR pattern 5.

In this embodiment of this application, solutions in one or more of the foregoing six indication manners may be combined with each other to obtain different solutions. Signaling in the solutions and embodiments of this application, for example, the indication information, the first configuration information, the second configuration information, and the mapping relationship, may be sent in a broadcast or multicast manner by the network device to the terminal device in at least one of broadcast information including a SIB 1, other system information (other system information, OSI), a MIB, and the like. Sending the foregoing signaling to the terminal device in the broadcast or multicast manner can avoid scheduling different resources for different terminal devices to send the foregoing signaling, reduce signaling overheads of scheduling resources, and reduce system scheduling complexity.

In addition, if the signaling is sent in an RRC connection setup phase or a subsequent communication process, the network device may add the signaling to at least one piece of information of RRC signaling (for example, an RRC setup (RRC setup) message, RRC reconfiguration (RRC Reconfiguration) signaling, or RRC resume (RRC Resume) signaling), downlink control information (downlink control information, DCI), group DCI, and a media access control (media access control, MAC) control element (control element, CE), or indicate the signaling/parameter value to the terminal device in a table manner, or send the signaling to the terminal device during data transmission or in a separately allocated PDSCH bearer in the unicast or multicast manner. An advantage of sending the foregoing signaling to the terminal device separately or in a group is that a parameter value of each terminal device/each group of terminal devices can be flexibly controlled, and different parameter values are configured for the terminal device based on different link budgets of different locations, different areas, or the like of the terminal device, to optimize system transmit power efficiency and optimize terminal device communication performance/system communication performance. For example, different TR patterns may be configured and used (for example, different quantities of subcarriers are configured in the TR patterns) based on different geographical locations of the terminal device, different required link budgets, and different signal transmit power or power efficiency requirements, to optimize PAPR suppression performance and spectral efficiency of each terminal device/each group of terminal devices, avoid an excessive waste of spectrum resources, and improve overall communication performance of the terminal device and a system.

S503: The terminal device sends or receives information based on the first TR pattern through the first beam between the first moment and the second moment, and sends or receives information based on the second TR pattern through the second beam since the second moment.

After determining a TR pattern corresponding to the serving beam, the terminal device sends information to the network device or receives information from the network device through the serving beam and the TR pattern corresponding to the serving beam. For example, the terminal device sends or receives information based on the first TR pattern through the first beam between the first moment and the second moment, and sends or receives information based on the second TR pattern through the second beam since the second moment. Interference is generated when the reserved carrier is used. Therefore, in this embodiment of this application, noise interference generated during PAPR suppression may not point to a beam direction with a wanted signal, to reduce interference. Specifically, a functional module, for example, referred to as a “reserving partial tones” module, may be disposed in the terminal device and/or the network device. The module may control noise generated by a beam using the TR pattern not to point to a beam not using the TR.

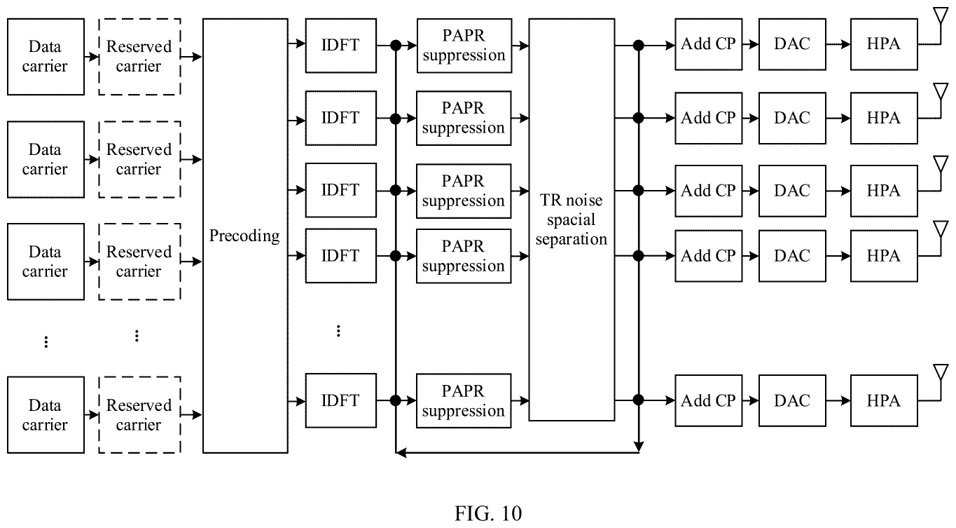

FIG. 10 is a block diagram of a principle of multi-beam PAPR suppression according to an embodiment of this application. As shown in FIG. 10, a PAPR suppression (PAPR reduction TR scheme) module and a TR noise spatial separation (TR noise spatial separation) module may be added on the basis of a transmit end precoding (precoding) module and an IDFT module. Based on the framework in FIG. 10, a data processing procedure may be as follows: A baseband signal (QAM symbol) is mapped to a data carrier, and transmitted data is not mapped to a reserved carrier used for PAPR suppression. A mapped signal sequentially passes through the precoding module, the IDFT module, the PAPR suppression module, the TR noise spatial separation module, a cyclic shift module, a digital-to-analog converter (digital-to-analog converter, DAC), an HPA (high power amplifier), and the like, and is sent through an antenna.

For example, it is assumed that Sₖ is a frequency domain constellation mapping signal vector (B×1 vector) of B (B>1) beams on a subcarrier k. The Sₖ signal vector passes through the “reserving partial tones” module, and a subcarrier on a beam with a reserved carrier is nulled, that is, set to zero, and no data is placed. A precoding matrix Wₖ of data on the subcarrier k is a P×B matrix, where P indicates a quantity of antennas, and B indicates a quantity of beams. Data obtained by precoding the original constellation mapping signal vector Sₖ is as follows:

$${\overline{S}}_{k} = {W}_{k} {S}_{k}$$

PAPR suppression is performed on Sₖ, and spatial separation processing is performed on TR noise generated due to TR in a suppression process, which specifically includes the following steps (1) to (7).

(1) The data obtained through precoding is transformed to time domain through inverse discrete Fourier transform (inverse discrete Fourier transform, IDFT). Frequency domain data S̅ on an antenna is used as an example. S̅ indicates that a frequency domain data vector of an antenna obtained through precoding satisfies:

$$x = IDFT ( \overline{S} )$$

(2) PAPR suppression is performed on time domain data of each antenna by using the TR. One piece of antenna data x is used as an example. A time domain signal obtained through PAPR suppression satisfies:

$${x}_{TR} = TR ( x )$$

(3) The time domain signal obtained through PAPR suppression is input to the TR noise spatial separation module, which is also called the “TR noise spatial separation” module. This module can perform spatial filtering or spatial separation on the noise generated during PAPR suppression. This module first subtracts data obtained through PAPR suppression from data before PAPR suppression is performed, and an obtained time domain TR noise satisfies:

$${Noise}_{TR \_ TD} = {x}_{TR} - x$$

(4) If the time domain TR noise is transformed to frequency domain, the following is satisfied:

$${Noise}_{TR \_ FD} = DFT ( {Noise}_{TR \_ TD} )$$

(5) TR noise on a plurality of antennas is mapped to a beam direction in which a TR reserved carrier exists and/or a beam direction in which no wanted signal exists. This process is also referred to as spatial separation. After this process, the TR noise satisfies:

$${Noise}_{projec \_ FD , k} = ( I - {W}_{nonTR , k} {W}_{nonTR , k}^{pinv} ) {Noise}_{TR \_ FD , k}$$

I indicates a unit matrix, W_{nonTR,k} indicates a beam precoding matrix without a TR reserved carrier on the subcarrier k,W_{nonTR,k} is a P×BnonTR matrix, BnonTR indicates a quantity of beams without a TR reserved carrier, and W_{nonTR,k}^{pinv} indicates a pseudo-inverse matrix of W_{nonTR,k} and is a BnonTR×P matrix.

Alternatively, the TR noise obtained through spatial separation satisfies:

$${Noise}_{projec \_ FD , k} = {W}_{TR , k} {W}_{TR , k}^{pinv} {Noise}_{TR \_ FD , k}$$

I indicates a unit matrix, W_{TR,k} indicates a beam precoding matrix in a beam direction of the subcarrier k of the TR reserved carrier and/or a beam precoding matrix in a beam direction without a wanted signal, W_{TR,k} is a P×BTR matrix, BTR indicates a quantity of beams with the TR reserved carrier and/or without a wanted signal beam, and W_{TR,k}^{pinv} indicates a pseudo-inverse matrix of W_{TR,k} and is a BTR×P matrix.

(6) Frequency domain TR noise obtained through spatial separation is transformed to time domain. Frequency domain TR noise Noise_{project_FD} on one of the antennas is used as an example:

$${Noise}_{project \_ TD} = IDFT ( {Noise}_{project \_ FD} )$$

(7) The time domain TR noise obtained through spatial separation is added to x_{TR}, to obtain an updated PAPR suppression signal. The antenna data x is as an example. A time domain signal of the updated PAPR suppression signal is represented as:

$$\hat{x} = x + {Noise}_{project \_ TD}$$

A process of steps (1) to (7) is referred to as one iteration. When a quantity of iterations reaches a threshold or PAPR suppression effect reaches a requirement, the iteration may be stopped, that is, an obtained updated PAPR suppression signal is output, for example, output to a cyclic prefix (cyclic prefix, CP) module. If the PAPR suppression effect does not meet the requirement after one iteration, a time domain signal \hat{x} of the updated PAPR suppression signal is used to replace data x in step (2), and steps (2) to (7) are repeatedly performed, that is, next iteration processing is performed.

In this embodiment of this application, the TR noise spatial separation module is added to the terminal device or the network device, to perform spatial (direction) control on interference noise generated during PAPR suppression, so that the interference noise does not point to a direction of a beam not using a reserved carrier. In this way, interference can be reduced, and spectrum utilization of the system can be improved.

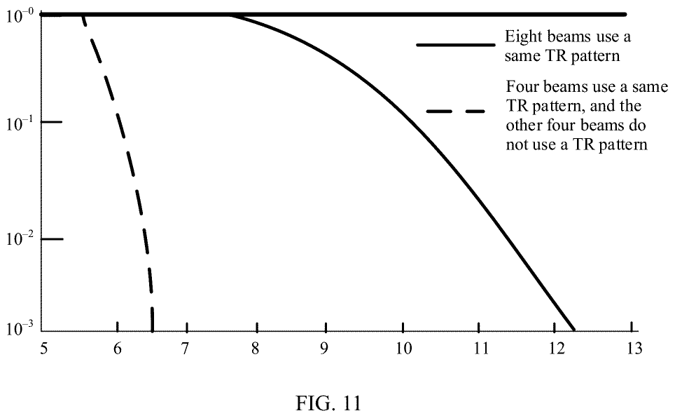

For example, FIG. 11 is a diagram of PAPR suppression effect achieved by using a solution according to an embodiment of this application. In FIG. 11, eight beams are used as an example. Four of the eight beams use the TR, and the other four beams do not use the TR to perform PAPR suppression. It can be learned from FIG. 8 that, in comparison with a solution in which the eight beams do not use the solution to perform PAPR suppression, the solution provided in this embodiment of this application has good PAPR suppression performance. It can be learned that, in the solution provided in this embodiment of this application, spectrum utilization can be further improved while PAPR suppression performance is ensured.

It should be noted that the solutions provided in embodiments of this application are also applicable to a scenario with a plurality of satellites. When signal coverage areas of the plurality of satellites have an overlapping area, the satellites may transmit, to each other through signaling (for example, Xn interface signaling), a beam using PAPR suppression or a wave position number of the beam, a used TR pattern, and/or PAPR suppression time. Each satellite performs spatial (direction) separation on interference noise based on a TR pattern used by another satellite to prevent the interference noise from interfering with a beam of the another satellite.

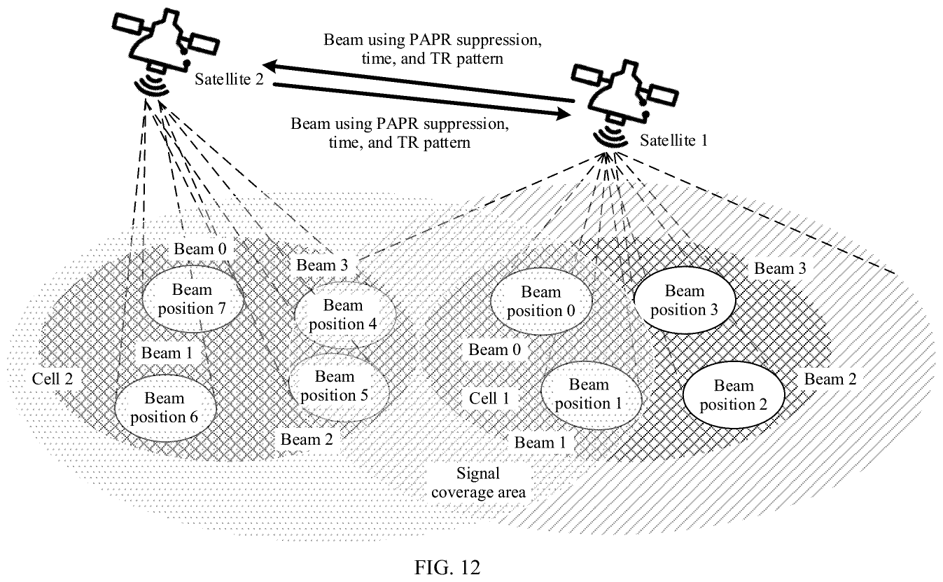

For example, FIG. 12 is a diagram of coverage of two satellites. That the two satellites in FIG. 12 are a satellite 1 and a satellite 2 is used for example. The satellite 1 covers a cell 1, and the satellite 2 covers a cell 2. Beams in the cell 1 include a beam 0 to a beam 3, and the beam 0 to the beam 3 correspondingly cover a wave position 0 to a wave position 3. Beams in the cell 2 include a beam 0 to a beam 3, and the beam 0 to the beam 3 correspondingly cover a wave position 4 to a wave position 7. A wave position may be understood as that a coverage area of a satellite, a part of area on the earth, or a ground area of the entire earth is divided based on a single-beam coverage area, and a coverage area of each beam is referred to as a wave position. As shown in FIG. 12, all wave positions form a coverage area of a satellite. It can be learned from FIG. 12 that a signal of the satellite 1 covers the wave position 4 and the wave position 5 of the satellite 2. PAPR suppression noise (interference noise) of the satellite 1 interferes with the wave position 4 and the wave position 5 of the satellite 2. In this case, the satellite 1 controls a direction of the PAPR suppression noise (interference noise) based on TR patterns of the wave position 4 and the wave position 5 of the satellite 2, to avoid interference.

In embodiments provided in this application, the methods provided in embodiments of this application are described from perspectives of the network device, the terminal device, and interaction between the terminal device and the network device. To implement functions in the method provided in the foregoing embodiments of this application, the terminal device and the network device may include a hardware structure and/or a software module, and the foregoing functions are implemented in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

The following describes a communication apparatus for implementing the foregoing method in embodiments of this application with reference to the accompanying drawings.

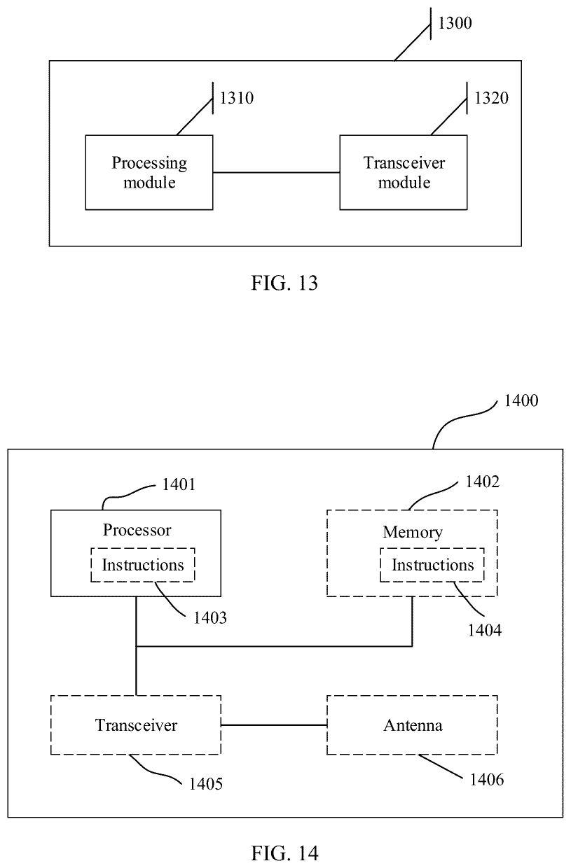

FIG. 13 is a block diagram of a communication apparatus 1300 according to an embodiment of this application. The communication apparatus 1300 may include a processing module 1310 and a transceiver module 1320. Optionally, a storage unit may be further included. The storage unit may be configured to store instructions (code or a program) and/or data. The processing module 1310 and the transceiver module 1320 may be coupled to the storage unit. For example, the processing module 1310 may read the instructions (the code or the program) and/or the data in the storage unit, to implement a corresponding method. The foregoing modules may be disposed independently, or may be partially or completely integrated.

In some possible implementations, the communication apparatus 1300 can correspondingly implement behavior and a function of the terminal device in the foregoing method embodiments. The communication apparatus 1300 may be the terminal device, or may be a component (for example, a chip or a circuit) used in the terminal device, or may be a chip or a chip set in the terminal device, or a part of a chip that is configured to perform a related method function.

For example, the processing module 1310 may be configured to: determine, at a first moment, a first TR pattern corresponding to a first beam, and determine, at a second moment, a second TR pattern corresponding to a second beam. The first beam is a serving beam of the communication apparatus 1300 at the first moment, the second beam is a serving beam of the communication apparatus 1300 at the second moment, and the first TR pattern is different from the second TR pattern. The transceiver module 1320 is configured to send or receive information based on a determined beam.

In an optional implementation, the transceiver module 1320 is specifically configured to: send or receive information through the first beam between the first moment and the second moment, and send or receive information through the second beam since the second moment.

In an optional implementation, the transceiver module 1320 is further configured to receive a mapping relationship from a network device. The mapping relationship indicates a correspondence between at least one TR pattern and at least one beam. The processing module 1310 is specifically configured to determine the first TR pattern based on the first beam and the mapping relationship.

In an optional implementation, that the mapping relationship indicates a correspondence between at least one TR pattern and at least one beam includes: The mapping relationship indicates a correspondence between the at least one TR pattern and a beam parameter set. The beam parameter set includes one or more of the following information: a BWP, a TCI, an SSB index, or a geographical location range.

In an optional implementation, the transceiver module 1320 is further configured to receive first configuration information from the network device. The first configuration information includes configuration information of a first beam set, and each beam in the first beam set corresponds to a third TR pattern. The first beam falls within the first beam set, and the processing module 1310 is specifically configured to determine that the first TR pattern is the third TR pattern.

In an optional implementation, the transceiver module 1320 is further configured to receive second configuration information from the network device. The second configuration information indicates the first TR pattern corresponding to the first beam and/or a TR pattern corresponding to at least one third beam. The at least one third beam is a beam adjacent to the first beam, and the processing module 1310 is specifically configured to determine the first TR pattern based on the second configuration information.

In an optional implementation, the transceiver module 1320 is further configured to receive indication information from the network device. The indication information indicates not to suppress a PAPR, or the indication information indicates that a TR pattern is associated with a cell, or the indication information indicates that a TR pattern is associated with a beam.

In some possible implementations, the communication apparatus 1300 can correspondingly implement behavior and a function of the network device in the foregoing method embodiments. The communication apparatus 1300 may be the network device, or may be a component (for example, a chip or a circuit) used in the network device, or may be a chip or a chip set in the network device, or a part of a chip that is configured to perform a related method function.

For example, the processing module 1310 may be configured to determine at least one TR pattern corresponding to at least two beams. The at least two beams include a first beam and a second beam, and a first TR pattern corresponding to the first beam is different from a second TR pattern corresponding to the second beam. The transceiver module 1320 is configured to indicate, to the terminal device, the at least one TR pattern corresponding to the at least two beams.

In an optional implementation, the transceiver module 1320 is specifically configured to send a mapping relationship to the terminal device. The mapping relationship indicates a correspondence between at least one TR pattern and at least one beam.

In an optional implementation, that the mapping relationship indicates a correspondence between at least one TR pattern and at least one beam includes: The mapping relationship indicates a correspondence between the at least one TR pattern and a beam parameter set. The beam parameter set includes one or more of the following information: a BWP, a TCI, an SSB index, or a geographical location range.

In an optional implementation, the transceiver module 1320 is specifically configured to send first configuration information to the terminal device. The first configuration information includes configuration information of a first beam set.

In an optional implementation, the transceiver module 1320 is specifically configured to send second configuration information to the terminal device. The second configuration information indicates the first TR pattern corresponding to the first beam and/or a TR pattern corresponding to at least one third beam, and the at least one third beam is a beam adjacent to the first beam.

In an optional implementation, the transceiver module 1320 is specifically configured to send indication information to the terminal device. The indication information indicates not to suppress a PAPR, or the indication information indicates that a TR pattern is associated with a cell, or the indication information indicates that a TR pattern is associated with a beam.

It should be understood that, in this embodiment of this application, the processing module 1310 may be implemented as a processor or a processor-related circuit component, and the transceiver module 1320 may be implemented as a transceiver or a transceiver-related circuit component, or a communication interface.

FIG. 14 is a block diagram of a communication apparatus 1400 according to an embodiment of this application. The communication apparatus 1400 may be a terminal device, and can implement a function of the terminal device in the method provided in embodiments of this application. Alternatively, the communication apparatus 1400 may be an apparatus that can support the terminal device in implementing a corresponding function in the method provided in embodiments of this application. The communication apparatus 1400 may be a chip system. In this embodiment of this application, the chip system may include a chip, or may include a chip and another discrete component. For a specific function, refer to descriptions of the foregoing method embodiments. The communication apparatus 1400 may alternatively be a network device, and can implement a function of the network device in the method provided in embodiments of this application. The communication apparatus 1400 may alternatively be an apparatus that can support the network device in implementing a corresponding function in the method provided in embodiments of this application. The communication apparatus 1400 may be the chip system. In this embodiment of this application, the chip system may include a chip, or may include a chip and another discrete component. For a specific function, refer to descriptions of the foregoing method embodiments.

The communication apparatus 1400 includes one or more processors 1401 that may be configured to implement or support the communication apparatus 1400 in implementing the function of the terminal device in the method provided in embodiments of this application. For details, refer to the detailed descriptions in the method example. Details are not described herein again. The one or more processors 1401 may alternatively be configured to implement or support the communication apparatus 1400 in implementing the function of the network device in the method provided in embodiments of this application. For details, refer to the detailed descriptions in the method example. Details are not described herein again. The processor 1401 may also be referred to as a processing unit or a processing module, and may implement a specific control function. The processor 1401 may be a general-purpose processor, a special-purpose processor, or the like. For example, the processor 1401 includes a central processing unit, an application processor, a modem processor, a graphics processor, an image signal processor, a digital signal processor, a video codec processor, a controller, a memory, a neural network processor, and/or the like. The central processing unit may be configured to control the communication apparatus 1400, execute software programs, and/or process data. Different processors may be independent components, or may be integrated into one or more processors, for example, integrated into one or more application-specific integrated circuits.

Optionally, the communication apparatus 1400 includes one or more memories 1402, configured to store instructions 1404. The instructions may be run on the processor 1401, so that the communication apparatus 1400 performs the method described in the foregoing method embodiments. The memory 1402 and the processor 1401 may be separately disposed, or may be integrated together, or it may be considered as that the memory 1402 is coupled to the processor 1401. The coupling in this embodiment of this application may be an indirect coupling or a communication connection between apparatuses, units, or modules in an electrical form, a mechanical form, or another form, and is used for information exchange between the apparatuses, the units, or the modules. The processor 1401 may collaboratively operate with the memory 1402. At least one of the at least one memory may be included in the processor. It should be noted that the memory 1402 is not mandatory. Therefore, the memory 1402 is represented by using dashed lines in FIG. 14.

Optionally, the memory 1402 may further store data. The processor and the memory may be separately disposed, or may be integrated together. In embodiments of this application, the memory 1402 may be a non-volatile memory, for example, a hard disk drive (hard disk drive, HDD) or a solid-state drive (solid-state drive, SSD), or may be a volatile memory (volatile memory), for example, a random access memory (random access memory, RAM). The memory is any other medium that can carry or store expected program code in a form of an instruction or a data structure and that can be accessed by a computer, but is not limited thereto. The memory in embodiments of this application may alternatively be a circuit or any other apparatus that can implement a storage function, and is configured to store program instructions and/or data.

Optionally, the communication apparatus 1400 may include instructions 1403 (which may also be referred to as code or programs sometimes), and the instructions 1403 may be run on the processor, to enable the communication apparatus 1400 to perform the method described in the foregoing embodiments. The processor 1401 may store data.

Optionally, the communication apparatus 1400 may further include a transceiver 1405 and an antenna 1406. The transceiver 1405 may be referred to as a transceiver unit, a transceiver module, a transceiver machine, a transceiver circuit, a transceiver, an input/output interface, or the like, and is configured to implement a receiving and sending function of the communication apparatus 1400 through the antenna 1406.

The processor 1401 and the transceiver 1405 described in this application may be implemented on an integrated circuit (integrated circuit, IC), an analog IC, a radio frequency identification (radio frequency identification, RFID) circuit, a mixed signal IC, an ASIC, a printed circuit board (printed circuit board, PCB), an electronic device, or the like. The communication apparatus described in this specification may be implemented by an independent device (for example, an independent integrated circuit or a mobile phone), or may be a part of a large device (for example, a module that may be embedded in another device). For details, refer to the foregoing descriptions about the terminal device and the network device. Details are not described herein again.

Optionally, the communication apparatus 1400 may further include one or more of the following components: a wireless communication module, an audio module, an external memory interface, an internal memory, a universal serial bus (universal serial bus, USB) interface, a power management module, an antenna, a speaker, a microphone, an input/output module, a sensor module, a motor, a camera, a display, or the like. It may be understood that in some embodiments, the communication apparatus 1400 may include more or fewer components, or some components are integrated, or some components are split. The components may be implemented by hardware, software, or a combination of software and hardware.

It should be noted that the communication apparatus in the foregoing embodiments may be a terminal device (or a network device), or may be a circuit, or may be a chip used in a terminal device (or a network device), or may be another combined component or component that has a function of the terminal device (or the network device), or the like. When the communication apparatus is a terminal device (or a network device), the transceiver module may be a transceiver, and may include an antenna, a radio frequency circuit, and the like. The processing module may be a processor, for example, a central processing module (central processing unit, CPU). When the communication apparatus is a component having a function of the foregoing terminal device (or the network device), the transceiver module may be a radio frequency unit, and the processing module may be a processor. When the communication apparatus is a chip system, the communication apparatus may be a field programmable gate array (field programmable gate array, FPGA), an application specific integrated chip (application specific integrated circuit, ASIC), a system on chip (system on chip, SoC), a CPU, a network processor (network processor, NP), a digital signal processing circuit (digital signal processor, DSP), a micro controller (micro controller unit, MCU), a programmable controller (programmable logic device, PLD), or another integrated chip. The processing module may be a processor of the chip system. The transceiver module or a communication interface may be an input/output interface or an interface circuit of the chip system. For example, the interface circuit may be a code/data read/write interface circuit. The interface circuit may be configured to receive code instructions (the code instructions are stored in the memory, and may be directly read from the memory, or may be read from the memory via another device) and transmit the code instructions to the processor. The processor may be configured to run the code instructions to perform the method in the foregoing method embodiments. For another example, the interface circuit may alternatively be a signal transmission interface circuit between a communication processor and the transceiver machine.

When the communication apparatus is a chip-type apparatus or circuit, the apparatus may include a transceiver unit and a processing unit. The transceiver unit may be an input/output circuit and/or a communication interface. The processing unit is an integrated processor, a microprocessor, or an integrated circuit.

An embodiment of this application further provides a communication system. Specifically, the communication system includes at least one terminal device and at least one network device. For example, the communication system includes a terminal device and a network device that are configured to implement related functions in FIG. 5. For details, refer to the related descriptions in the foregoing method embodiments. Details are not described herein again.

An embodiment of this application further provides a computer-readable storage medium, including instructions. When the instructions are run on a computer, the computer is enabled to perform the method performed by the terminal device or the network device in FIG. 5.

An embodiment of this application further provides a computer program product, including instructions. When the instructions are run on a computer, the computer is enabled to perform the method performed by the terminal device or the network device in FIG. 5.

An embodiment of this application provides a chip system. The chip system includes a processor, and may further include a memory, configured to implement a function of the terminal device in the foregoing method, or configured to implement a function of the network device in the foregoing method. The chip system may include a chip, or may include a chip and another discrete component.

It should be understood that sequence numbers of the foregoing processes do not mean execution sequences in various embodiments of this application. The execution sequences of the processes should be determined based on functions and internal logic of the processes, and should not be construed as any limitation on the implementation processes of embodiments of this application.

A person of ordinary skill in the art may be aware that, in combination with illustrative logical blocks (illustrative logical blocks) described in embodiments disclosed in this specification and steps (steps) may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered as that the implementation goes beyond the scope of this application.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus and method may be implemented in other manners. For example, the foregoing apparatus embodiments are merely examples. For example, division of the units is merely logical function division and may be other division during actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or the communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected based on actual requirements to achieve objectives of the solutions of embodiments.

When the functions are implemented in the form of a software functional unit and sold or used as an independent product, the functions may be stored in a computer-readable storage medium. Based on such an understanding, the technical solutions of this application essentially, or some of the technical solutions may be embodied in a form of a software product. The computer software product is stored in a storage medium, and includes several instructions for enabling a computer device (which may be a personal computer, a server, a network device, or the like) to perform all or some steps of the methods in embodiments of this application. The foregoing storage medium includes any medium, for example, a USB flash drive, a removable hard disk, a read-only memory (read-only memory, ROM), a RAM, a magnetic disk, or an optical disc, that can store program code.

It is clear that a person skilled in the art can make various modifications and variations to this application without departing from the scope of this application. This application is intended to cover these modifications and variations of this application provided that they fall within the scope of protection defined by the following claims and their equivalent technologies.

1. A communication method, comprising:
determining, by a first communication apparatus at a first moment, a first tone reservation (TR) pattern corresponding to a first beam, wherein the first beam is a serving beam of the first communication apparatus at the first moment; and
determining, by the first communication apparatus at a second moment, a second tone reservation (TR) pattern corresponding to a second beam, wherein the second beam is a serving beam of the first communication apparatus at the second moment, and the first TR pattern is different from the second TR pattern.

2. The method according to claim 1, wherein the first communication apparatus sends or receives information through the first beam between the first moment and the second moment, and sends or receives information through the second beam since the second moment.

3. The method according to claim 1, wherein the determining, by a first communication apparatus at a first moment, a first TR pattern corresponding to a first beam comprises:
receiving, by the first communication apparatus, a mapping relationship from a second communication apparatus, wherein the mapping relationship indicates a correspondence between at least one TR pattern and at least one beam; and
determining, by the first communication apparatus, the first TR pattern based on the first beam and the mapping relationship.

4. The method according to claim 3, wherein that the mapping relationship indicates a correspondence between at least one TR pattern and at least one beam comprises:
that the mapping relationship indicates a correspondence between the at least one TR pattern and a beam parameter set, wherein the beam parameter set comprises one or more of the following information: a bandwidth part (BWP), a transmission configuration indicator (TCI), a synchronization signal block index, or a geographical location range.

5. The method according to claim 1, wherein the determining, by a first communication apparatus at a first moment, a first TR pattern corresponding to a first beam comprises:
receiving, by the first communication apparatus, first configuration information from a second communication apparatus, wherein the first configuration information comprises configuration information of a first beam set, and each beam in the first beam set corresponds to a third TR pattern; and
when the first beam falls within the first beam set, determining, by the first communication apparatus, that the first TR pattern is the third TR pattern.

6. The method according to claim 1, wherein the determining, by a first communication apparatus at a first moment, a first TR pattern corresponding to a first beam comprises:
receiving, by the first communication apparatus, second configuration information from a second communication apparatus, wherein the second configuration information indicates at least one of the first TR pattern corresponding to the first beam or a TR pattern corresponding to at least one third beam, and the at least one third beam is a beam adjacent to the first beam; and
determining, by the first communication apparatus, the first TR pattern based on the second configuration information.

7. The method according to claim 1, wherein the method further comprises:
receiving, by the first communication apparatus, indication information from a second communication apparatus, wherein the indication information indicates not to suppress a peak-to-average power ratio (PAPR), or the indication information indicates that a TR pattern is associated with a cell, or the indication information indicates that a TR pattern is associated with a beam.

8. A first communication apparatus, comprising:
a transceiver;
at least one processor; and
one or more memories coupled to the at least one processor and storing programming instructions for execution by the at least one processor to cause the apparatus to:
determine, at a first moment, a first tone reservation TR pattern corresponding to a first beam, and determine, at a second moment, a second tone reservation (TR) pattern corresponding to a second beam, wherein the first beam is a serving beam of the first communication apparatus at the first moment, the second beam is a serving beam of the first communication apparatus at the second moment, and the first TR pattern is different from the second TR pattern; and
send or receive, by using the transceiver, information based on a determined beam.

9. The apparatus according to claim 8, wherein the programming instructions, when executed by the at least one processor, cause the apparatus to:
send or receive, by using the transceiver, information through the first beam between the first moment and the second moment, and send or receive information through the second beam since the second moment.

10. The apparatus according to claim 8, wherein the programming instructions, when executed by the at least one processor, cause the apparatus to
receive, by using the transceiver, a mapping relationship from a second communication apparatus, and the mapping relationship indicates a correspondence between at least one TR pattern and at least one beam; and
determine the first TR pattern based on the first beam and the mapping relationship.

11. The apparatus according to claim 10, wherein that the mapping relationship indicates a correspondence between at least one TR pattern and at least one beam comprises:
that the mapping relationship indicates a correspondence between the at least one TR pattern and a beam parameter set, wherein the beam parameter set comprises one or more of the following information: a bandwidth part (BWP), a transmission configuration indicator (TCI), a synchronization signal block index, or a geographical location range.

12. The apparatus according to claim 8, wherein the programming instructions, when executed by the at least one processor, cause the apparatus to:
receive, by using the transceiver, first configuration information from a second communication apparatus, the first configuration information comprises configuration information of a first beam set, and each beam in the first beam set corresponds to a third TR pattern, and wherein the first beam falls within the first beam set; and
determine that the first TR pattern is the third TR pattern.

13. The apparatus according to claim 8, wherein the programming instructions, when executed by the at least one processor, cause the apparatus to:
receive, by using the transceiver, second configuration information from a second communication apparatus, the second configuration information indicates at least one of the first TR pattern corresponding to the first beam or a TR pattern corresponding to at least one third beam, and the at least one third beam is a beam adjacent to the first beam; and
determine the first TR pattern based on the second configuration information.

14. The apparatus according to claim 8, wherein the programming instructions, when executed by the at least one processor, cause the apparatus to:
receive, by using the transceiver, indication information from a second communication apparatus, wherein the indication information indicates not to suppress a PAPR, or the indication information indicates that a TR pattern is associated with a cell, or the indication information indicates that a TR pattern is associated with a beam.

15. A non-transitory computer-readable storage medium, wherein the computer-readable storage medium stores a computer program, and when the computer program is executed by a computer, the computer is enabled to perform steps comprising:
determining, by a first communication apparatus at a first moment, a first tone reservation (TR) pattern corresponding to a first beam, wherein the first beam is a serving beam of the first communication apparatus at the first moment; and
determining, by the first communication apparatus at a second moment, a second tone reservation (TR) pattern corresponding to a second beam, wherein the second beam is a serving beam of the first communication apparatus at the second moment, and the first TR pattern is different from the second TR pattern.

16. The medium according to claim 15, wherein the first communication apparatus sends or receives information through the first beam between the first moment and the second moment, and sends or receives information through the second beam since the second moment.

17. The medium according to claim 15, wherein the determining, by a first communication apparatus at a first moment, a first TR pattern corresponding to a first beam comprises:
receiving, by the first communication apparatus, a mapping relationship from a second communication apparatus, wherein the mapping relationship indicates a correspondence between at least one TR pattern and at least one beam; and
determining, by the first communication apparatus, the first TR pattern based on the first beam and the mapping relationship.

18. The medium according to claim 17, wherein that the mapping relationship indicates a correspondence between at least one TR pattern and at least one beam comprises:
that the mapping relationship indicates a correspondence between the at least one TR pattern and a beam parameter set, wherein the beam parameter set comprises one or more of the following information: a bandwidth part (BWP), a transmission configuration indicator (TCI), a synchronization signal block index, or a geographical location range.

19. The medium according to claim 15, wherein the determining, by a first communication apparatus at a first moment, a first TR pattern corresponding to a first beam comprises:
receiving, by the first communication apparatus, first configuration information from a second communication apparatus, wherein the first configuration information comprises configuration information of a first beam set, and each beam in the first beam set corresponds to a third TR pattern; and
when the first beam falls within the first beam set, determining, by the first communication apparatus, that the first TR pattern is the third TR pattern.

20. The medium according to claim 15, wherein the determining, by a first communication apparatus at a first moment, a first TR pattern corresponding to a first beam comprises:
receiving, by the first communication apparatus, second configuration information from a second communication apparatus, wherein the second configuration information indicates at least one of the first TR pattern corresponding to the first beam or a TR pattern corresponding to at least one third beam, and the at least one third beam is a beam adjacent to the first beam; and
determining, by the first communication apparatus, the first TR pattern based on the second configuration information.
